(19) United States
(12) Patent Application Publication
(10) Pub. No.: US 2026/0179327 A1
(43) Pub. Date: Jun. 25, 2026

(54) METHOD FOR MANAGING VISUAL CONTENT, HOST, AND COMPUTER-READABLE STORAGE MEDIUM

(71) Applicant: HTC Corporation, Taoyuan City (TW)

(72) Inventor: Yao-Han Yen, Taoyuan City (TW)

(73) Assignee: HTC Corporation, Taoyuan City (TW)

(21) Appl. No.: 18/991,702

(22) Filed: Dec. 23, 2024

(51) Int. Cl. G06T 19/00; G06F 3/033

(52) U.S. Cl. CPC G06T 19/00; G06F 3/033

(57) ABSTRACT

The embodiments of the disclosure provide a method for managing visual content, a host, and a computer-readable storage medium. The method includes, during a recording phase for recording 3D visual content, recording content information associated with the 3D visual content, wherein the content information associated with the 3D visual content includes at least one of an input event occurring on an input device, an object pose of a target object, and 3D object information corresponding to a 3D content object; and during a playback phase for playing back the recorded 3D visual content, playing back the recorded 3D visual content based on the content information of the recorded 3D visual content.

### BACKGROUND

### Technical Field

The disclosure relates to a mechanism for providing visual content, and particularly relates to a method for managing visual content, a host, and a computer-readable storage medium.

### Description of Related Art

In extended reality (XR) technology (such as virtual reality (VR), augmented reality (AR), mixed reality (MR), etc.), recording 3D visual content and allowing users to play it back on a head-mounted display (HMD) has become a mature application. Such a technology is mainly used in the field of training and education, especially in situations that require a highly immersive learning experience, such as medical simulation training, engineering technology teaching, and complex equipment operation drills.

In the existing process of recording 3D visual content, the relevant recording/playback software generally only targets the poses (which may be characterized in the form of six degrees of freedom) of various trackable objects (such as HMDs, handheld controllers, trackers, wearable devices, etc.) for recording/playback. In this case, the recorded 3D visual content will be limited, which may affect learning effectiveness.

### SUMMARY

In view of this, the disclosure provides a method for managing visual content, a host, and a computer-readable storage medium, which may be used to solve the above technical problems.

Embodiments of the disclosure provide a method for managing visual content, executed by a host, including: during a recording phase for recording 3D visual content, recording content information associated with the 3D visual content, wherein the content information associated with the 3D visual content includes at least one of an input event occurring on an input device, an object pose of a target object, and 3D object information corresponding to a 3D content object; and during a playback phase for playing back the recorded 3D visual content, playing back the recorded 3D visual content based on the content information of the recorded 3D visual content.

Embodiments of the disclosure provide a host including a storage circuit and a processor. The storage circuit stores a program code. The processor is coupled to the storage circuit and configured to access the program code to execute: during a recording phase for recording 3D visual content, recording content information associated with the 3D visual content, wherein the content information associated with the 3D visual content includes at least one of an input event occurring on an input device, an object pose of a target object, and 3D object information corresponding to a 3D content object; and during a playback phase for playing back the recorded 3D visual content, playing back the recorded 3D visual content based on the content information of the recorded 3D visual content.

Embodiments of the disclosure provide a non-transitory computer-readable storage medium. The non-transitory computer-readable storage medium records an executable computer program. The executable computer program is loaded by a host to perform the following steps: during a recording phase for recording 3D visual content, recording content information associated with the 3D visual content, wherein the content information associated with the 3D visual content includes at least one of an input event occurring on an input device, an object pose of a target object, and 3D object information corresponding to a 3D content object; and during a playback phase for playing back the recorded 3D visual content, playing back the recorded 3D visual content based on the content information of the recorded 3D visual content.

### BRIEF DESCRIPTION OF THE DRAWINGS

FIG. 1 is a schematic diagram of a host, an input device, a target object, and a 3D content object according to an embodiment of the disclosure.

FIG. 2 is a flowchart of a method for managing visual content according to an embodiment of the disclosure.

FIG. 3 is a schematic diagram of recording content information according to a second embodiment of the disclosure.

FIG. 4 is a schematic diagram of playing back 3D visual content according to a specified time point according to the embodiment of FIG. 3.

FIG. 5 is a schematic diagram of recording content information according to an embodiment of the disclosure.

FIG. 6 is a schematic diagram of a data array according to FIG. 5.

FIG. 7 is a schematic diagram of a pause event according to an embodiment of the disclosure.

FIG. 8 is a playback schematic diagram according to FIG. 7.

FIG. 9 is a schematic diagram of a recording phase according to an embodiment of the disclosure.

FIG. 10 is a schematic diagram of playing back 3D visual content according to FIG. 9.

FIG. 11 is a schematic diagram of recording coordinate origins according to an embodiment of the disclosure.

### DESCRIPTION OF THE EMBODIMENTS

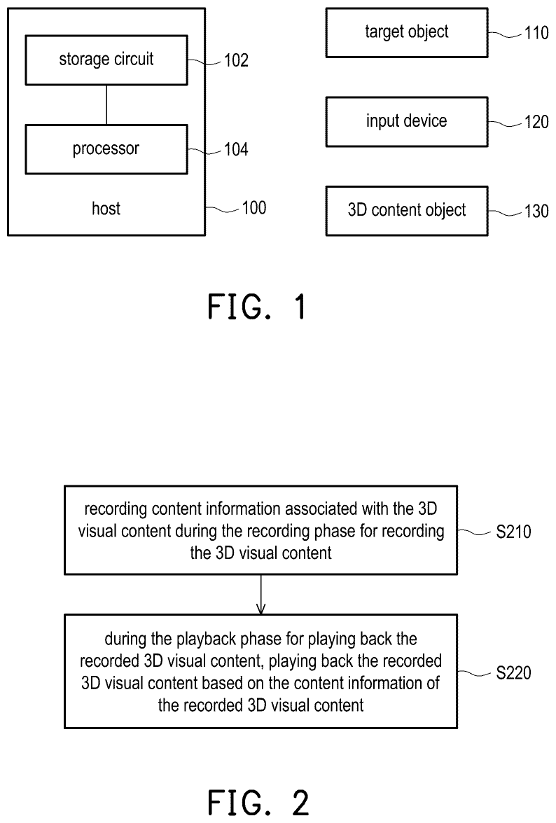

Referring to FIG. 1, FIG. 1 is a schematic diagram of a host, an input device, a target object, and a 3D content object according to an embodiment of the disclosure. In some embodiments, a host 100 is, for example, a device that may perform tracking technologies such as inside-out tracking, outside-in tracking, etc., to track its own pose and the object poses of other target objects 110. The pose of the host 100 and the pose of the object may be presented in the form of six degrees of freedom, but are not limited thereto.

In an embodiment, the host 100 may be any smart device and/or computer device capable of providing visual content of a reality service, such as a virtual reality (VR) service, an augmented reality (AR) service, a mixed reality (MR) service, and/or an extended reality (XR) service, but the disclosure is not limited thereto. In some embodiments, the host 100 may be a head-mounted display (HMD) capable of displaying/providing visual content (e.g., AR/VR/MR content) for the wearer/user to view. In order to better understand the concept of the disclosure, it is assumed below that the host 100 is an HMD and may be used to provide the rendered visual content for users to view, but the disclosure is not limited thereto.

In the embodiment of the disclosure, the target object 110 is, for example, a trackable object whose pose may be tracked by the host 100, or a tracking device and/or tracker that may provide the tracked pose as the above-mentioned object pose to the host 100 after tracking its own pose. In some embodiments, the target object 110 is, for example, an HMD, a handheld controller, a tracker, a wearable device, and/or various trackable peripheral devices, but the disclosure is not limited thereto.

In the embodiment of the disclosure, the input device 120 is, for example, various devices connected to the host 100 and may be used by the user to perform input operations, such as a keyboard, a mouse, and/or various controllers. In some embodiments, the device connected to the host 100 may be the target object 110 and the input device 120 at the same time. For example, a handheld controller (such as a VR controller) disposed with physical input elements (such as physical buttons and/or joysticks) allows the user to perform input operations (pressing buttons and/or pushing joysticks), and thus may be regarded as an input device 120. In addition, since the pose of the handheld controller may be tracked by the host 100 through, for example, inside-out tracking technology, the handheld controller may also be regarded as a target object 110, but the disclosure is not limited thereto.

In the embodiment of the disclosure, a 3D content object 130 is, for example, a virtual object (such as a VR, AR, and/or MR object) rendered by the host 100. In an embodiment, the host 100 may render the 3D content object 130 based on 3D object information corresponding to the 3D content object 130. In different embodiments, the 3D object information includes, for example, the content object pose, texture, mesh, etc. of the 3D content object 130, but the disclosure is not limited thereto.

In FIG. 1, the host 100 includes a storage circuit 102 and a processor 104. The storage circuit 102 is, for example, any form of fixed or movable random access memory (RAM), a read-only memory (ROM), a flash memory, a hard disk drive, or other similar devices, or a combination thereof, which may be used to record a plurality of program codes or modules.

The processor 104 is coupled to the storage circuit 102, and may be a general-purpose processor, a special-purpose processor, a traditional processor, a digital signal processor, a plurality of microprocessors, one or more microprocessors combined with a digital signal processor core, a controller, a microcontroller, an application specific integrated circuit (ASIC), a field programmable gate array (FPGA), any other kind of integrated circuit, state machine, advanced RISC machine (ARM) processors, and similar products.

In an embodiment of the disclosure, the processor 104 may access the modules and program codes recorded in the storage circuit 102 to implement the method for managing visual content proposed by the disclosure, the details of which are described in detail below.

Referring to FIG. 2, FIG. 2 is a flowchart of a method for managing visual content according to an embodiment of the disclosure. The method of the embodiment may be executed by the host 100 depicted in FIG. 1. The details of each step in FIG. 2 will be described below with reference to the components shown in FIG. 1.

First, in step S210, the processor 104 records content information associated with the 3D visual content during the recording phase for recording the 3D visual content.

In embodiments of the disclosure, software for recording and/or playing back the 3D visual content (e.g., VR teaching content) may be run on the host 100. In an embodiment, during the recording phase for recording 3D visual content, the host 100 running the software may record at least one of the input event occurring on the input device 120, the object pose of the target object 110, and the 3D object information corresponding to the 3D content object 130.

For example, it is assumed that the scene under consideration is that the host 100 is displaying a rendered virtual object (which may be understood as one of the 3D content objects 130), and a teacher's hands are holding a corresponding handheld controller (which may be understood as one of the target objects 110), and the host 100 is connected to a keyboard (which may be understood as one of the input devices 120).

In this case, if the recording function of the above-mentioned software is triggered to enter the recording phase for recording the 3D visual content, then after the recording function is triggered, the software records at least one of the following information: (1) the input event occurring on the keyboard (for example, which buttons were pressed at which time points); (2) the pose (i.e., object pose) of each handheld controller at different time points; (3) the texture, pose, mesh, etc. of the above virtual objects at different time points.

In addition, as mentioned before, since the handheld controller may also be understood as one of the input devices 120, the software may also record the input event that occurs on each handheld controller (for example, which buttons were pressed at which time points, at which time points the joystick was pushed in which direction, etc.), but the disclosure is not limited thereto.

In some embodiments, the processor 104 may record at least one of the input event occurring on the input device 120, the object pose of the target object 110, and the 3D object information corresponding to the 3D content object 130 as content information associated with the 3D visual content in step S210, but the disclosure is not limited thereto.

In some embodiments, the content information of the 3D visual content may further include the audio signal received by the audio receiving device during the recording phase. Following the previous scenario, after the recording function is triggered, the software may record the audio signals input by the teacher to the audio receiving device connected to the host 100 at different time points as one of the content information of the 3D visual content.

Furthermore, in some embodiments, the content information of the 3D visual content may further include a system function call event associated with the 3D visual content. In an embodiment of the disclosure, the system function call event is, for example, a software event, which may execute a specific program code after being called, and such a specific program code may be configured with certain parameters to implement a specific function.

For example, it is assumed that the teacher uses the handheld controller as a brush to draw/write in the 3D space during the recording phase. In this example, if the teacher changes the stroke of the brush (such as color and/or size) at a certain time point during the recording phase, such a behavior may be recorded as a system function call event, and the time point when the stroke is changed is also recorded. In this example, the color and/or size of the stroke may be understood as parameters configured in the above-mentioned specific program code.

As another example, it is assumed that the teacher uses a handheld controller as a controller for a virtual object (such as a virtual light fixture) during the recording phase. In this example, if the teacher changes the status of the virtual object at a certain time point during the recording phase (such as adjusting the switch, color temperature and/or brightness of the virtual light fixture, etc.), such a behavior may be recorded as a system function call event, and the time point when the status of the virtual object is changed is also recorded. In this example, the status of the virtual object (such as switch, color temperature and/or brightness) may be understood as parameters configured in the above-mentioned specific program code.

In some embodiments, if the teacher calls a third-party application programming interface (API) during the recording phase, such a behavior may also be recorded as a system function call event, but the disclosure is not limited thereto.

In embodiments of the disclosure, the recording phase may be divided into a plurality of recording time intervals that have same or different lengths from each other, and the processor 104 may record content information associated with the 3D visual content in units of recording time intervals.

In the first embodiment, the processor 104 may record the input event occurring on the input device 120, the object pose of the target object 110, and the 3D object information corresponding to the 3D content object 130 detected during each recording time interval.

In embodiments of the disclosure, different forms of content information may be recorded in corresponding data arrays.

For example, it is assumed that an input event (hereinafter referred to as A1) occurring on the input device 120, an object pose (hereinafter referred to as B1) of the target object 110, and 3D object information (hereinafter referred to as C1) corresponding to the 3D content object 130 are detected in the i-th recording time interval among the plurality of recording time intervals. Then, for example, the processor 104 may add a data element corresponding into the i-th recording time interval in the data array corresponding to the input device 120, and the data element may record the above-mentioned input event A1. In addition, the processor 104 may also add a data element corresponding to the i-th recording time interval into the data array corresponding to the target object 110, and the data element may record the above-mentioned object pose B1. Similarly, the processor 104 may add a data element corresponding into the i-th recording time interval in the data array corresponding to the 3D content object 130, and the data element may record the above-mentioned 3D object information C1, but the disclosure is not limited thereto.

After implementing the means of the first embodiment, each of the above data arrays will include data elements corresponding to each recording time interval.

In some embodiments, in order to save the amount of data, the processor 104 may also record content information associated with the 3D visual content based on the method described in the second embodiment below.

In the second embodiment, in response to determining that the content information detected in the i-th recording time interval is different from the reference content information, the processor 104 may record the content information detected in the i-th recording time interval, and the content information detected in the i-th recording time interval is determined as the reference content information, where i is the index value. On the other hand, in response to determining that the content information detected in the i-th recording time interval is the same as the reference content information, the processor 104 may not record the content information detected in the i-th recording time interval and may maintain the reference content information.

In the second embodiment, for the first recording time interval, the processor 104 may directly record the detected content information, and determine the detected content information as the reference content information. In other words, the above method may be understood as being applicable to the situation where i is an integer greater than or equal to 2, but the disclosure is not limited thereto.

In other embodiments, the reference content information may also be preset to an unreasonable value, so that when i is 1, the processor 104 may still determine accordingly that the content information detected in the first recording time interval is different from the reference content information. In this case, the processor 104 may still record the content information detected in the first recording time interval, and determine the content information detected in the first recording time interval as the reference content information, but the disclosure is not limited thereto.

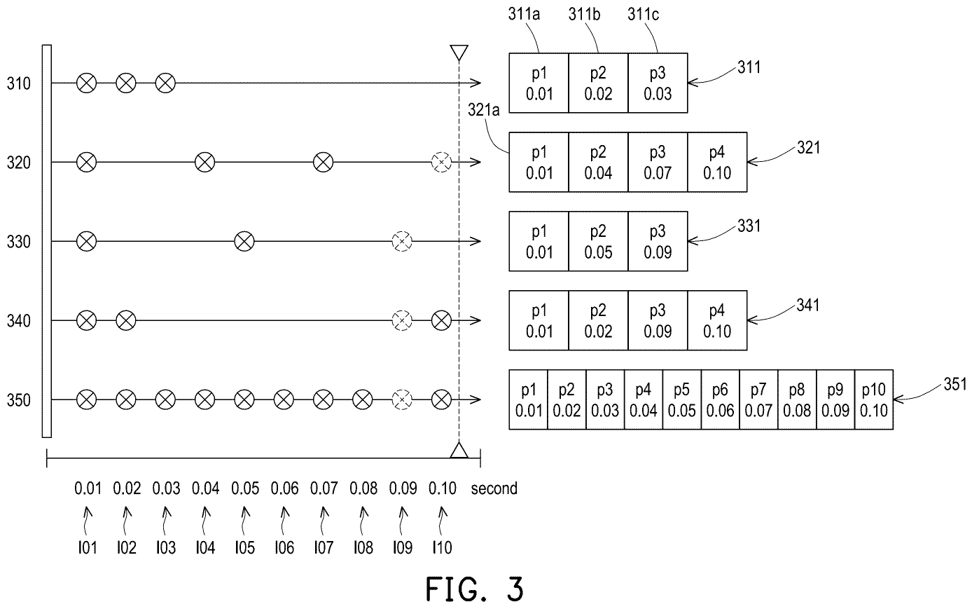

In order to make the concept of the second embodiment easier to understand, FIG. 3 is provided below for explanation.

Referring to FIG. 3, FIG. 3 is a schematic diagram of recording content information according to a second embodiment of the disclosure.

In the scenario of FIG. 3, it is assumed that the recording phase under consideration includes a recording time interval I01 to a recording time interval I10 (where the respective lengths of the recording time interval I01 to the recording time interval I10 are, for example, 10 ms).

In the embodiment, the processor 104 may, for example, detect individual object poses of the target objects 310, 320, 330, 340, and 350 as the considered content information.

Taking the target object 310 as an example, the processor 104 may, for example, record the object pose of the target object 310 detected in the recording time interval I01 (i.e., the first recording time interval), and may determine the content information detected in the recording time interval I01 as the reference content information. In FIG. 3, for example, the processor 104 may add a data element 311a corresponding to the recording time interval I01 (i.e., 0.01 ms) into a data array 311 corresponding to the target object 310, and the data element 311a may record the object pose of the target object 310 (i.e., data p1 in the data element 311a).

Thereafter, it is assumed that the object pose of the target object 310 detected by the processor 104 in the recording time interval I02 (i.e., the second recording time interval) is different from the object pose of the target object 310 detected by the processor 104 in the recording time interval I01 (for example, the current reference content information). In this case, in response to determining that the object pose detected in the recording time interval I02 is different from the reference content information, the processor 104 may record the object pose of the target object 310 detected in the recording time interval I02, and determine the object pose of the target object 310 detected in the recording time interval I02 as the reference content information.

In FIG. 3, for example, the processor 104 may add a data element 311b corresponding to the recording time interval I02 (i.e., 0.02 ms) into the data array 311 corresponding to the target object 310, and the data element 311b may record the object pose of the target object 310 (i.e., data in the data element 311b).

Thereafter, it is assumed that the object pose of the target object 310 detected by the processor 104 in the recording time interval I03 (i.e., the third recording time interval) is different from the object pose of the target object 310 detected by the processor 104 in the recording time interval I02 (for example, the current reference content information). In this case, in response to determining that the object pose detected in the recording time interval I03 is different from the reference content information, the processor 104 may record the object pose of the target object 310 detected in the recording time interval I03, and determine the object pose of the target object 310 detected in the recording time interval I03 as the reference content information.

In FIG. 3, for example, the processor 104 may add a data element 311c corresponding to the recording time interval I03 (i.e., 0.03 ms) into the data array 311 corresponding to the target object 310, and the data element 311c may record the object pose of the target object 310 (i.e., data p3 in the data element 311c).

Thereafter, it is assumed that the object pose of the target object 310 detected by the processor 104 in the recording time interval I04 (i.e., the fourth recording time interval) is the same as the object pose of the target object 310 detected by the processor 104 in the recording time interval I03 (for example, the current reference content information). In this case, in response to determining that the object pose detected in the recording time interval I03 is the same as the reference content information, the processor 104 may not record the object pose of the target object 310 detected in the recording time interval I04, and may maintain the reference content information (i.e., maintain the reference content information as the object pose of the target object 310 detected in the recording time interval I03).

In FIG. 3, for example, the processor 104 may not add any data elements corresponding to the recording time interval I04 (i.e., 0.04 ms) into the data array 311 corresponding to the target object 310.

In the embodiment, it is assumed that the object poses of the target object 310 detected in the recording time interval I05 (i.e., the 5th recording time interval) to the recording time interval I10 (i.e., the 10th recording time interval) are all the same as the object pose (i.e., reference content information) of the target object 310 detected in the recording time interval I03. In this case, the processor 104 may not add any data elements corresponding to the recording time interval I05 (i.e., 0.05 ms) into the recording time interval I10 (i.e., 0.10 ms) in the data array 311 corresponding to the target object 310.

In FIG. 3, the time axis located on the left side of the data array 311 may show three data points corresponding to the data elements 311a to 311c (each of which is shown as a circle with an x symbol) to facilitate identification.

Based on the similar principle, the processor 104 may accordingly construct a data array 321, a data array 331, a data array 341, and a data array 351 corresponding to the target object 320, the target object 330, the target object 340, and the target object 350 respectively. In the scenario of FIG. 3, the target object 350 is, for example, an object that moves frequently (e.g., a handheld controller), so the processor 104 may record related object poses as corresponding content information more frequently. In addition, the target object 340 is, for example, a static object in the recording time interval I03 to the recording time interval I08. Therefore, the processor 104 may not record the object pose of the target object 340 detected in the recording time interval I03 to the recording time interval I08, but the disclosure is not limited thereto.

In the second embodiment, since the processor 104 does not need to record the content information detected in each recording time interval, the amount of data may be correspondingly saved.

Referring to FIG. 2 again, in step S220, during the playback phase for playing back the recorded 3D visual content, the processor 104 plays back the recorded 3D visual content based on the content information of the recorded 3D visual content.

In an embodiment, during the playback phase for playing back 3D visual content, the host 100 running the software may play back the 3D visual content based on at least one of a recorded input event occurring on the input device 120, an object pose of the target object 110, and 3D object information corresponding to the 3D content object 130.

In an embodiment, in response to determining that the current playback time point in the playback phase corresponds to the i-th recording time interval, the processor 104 may obtain specific content information corresponding to the i-th recording time interval from the content information associated with the 3D visual content. Thereafter, the processor 104 may configure at least one of the current input event of the virtual input device object, the current object pose of the virtual target object, and the current 3D object information of the first 3D content object based on the specific content information corresponding to the i-th recording time interval.

In an embodiment of the disclosure, the virtual input device object, the virtual target object, and the first 3D content object are virtual objects in the played back 3D visual content, and respectively correspond to the input device 120, the target object 110, and the 3D content object 130.

For example, if the playback function of the software is triggered to enter a playback phase for playing back 3D visual content, the processor 104 may, for example, start playing back the 3D visual content after the playback function is triggered.

Taking FIG. 3 as an example, assuming that the current playback time point corresponds to the recording time interval I01, the processor 104 may, for example, read the content information corresponding to the recording time interval I01 from the data array 311 as specific content information for configuring the virtual target object corresponding to the target object 310. In this case, the processor 104 may, for example, configure the current object pose of the virtual target object corresponding to the target object 310 to correspond to the data p1 recorded in the data element 311a.

For example, assuming that the target object 310 is a wearable device, the played back 3D visual content may include a virtual wearable device corresponding to the target object 310. In this case, the processor 104 may configure the current object pose of the virtual wearable device based on the data p1 recorded in the data element 311a, so that the current object pose of the virtual wearable device may correspond to the object pose of the target object 310 recorded in the recording phase, but the disclosure is not limited thereto.

Similarly, the processor 104 may, for example, read the content information corresponding to the recording time interval I01 from the data array 321 as specific content information for configuring the virtual target object corresponding to the target object 320. In this case, the processor 104 may, for example, configure the current object pose of the virtual target object corresponding to the target object 320 to correspond to the data p1 recorded in a data element 321a.

For example, assuming that the target object 320 is a handheld controller, the played back 3D visual content may include a virtual handheld controller corresponding to the target object 320. In this case, the processor 104 may configure the current object pose of the virtual handheld controller based on the data p1 recorded in the data element 321a, so that the current object pose of the virtual handheld controller may correspond to the object pose of the target object 320 recorded in the recording phase, but the disclosure is not limited thereto.

Based on the similar principle, the processor 104 may accordingly configure the current object poses of the virtual target objects respectively corresponding to the target object 330, the target object 340, and the target object 350 in the recording time interval I01, the details of which will not be repeated herein.

Thereafter, assuming that the current playback time point proceeds to correspond to the recording time interval I02, the processor 104 may, for example, read the content information corresponding to the recording time interval I02 from the data array 311 as specific content information for configuring the virtual target object corresponding to the target object 310. In this case, the processor 104 may, for example, configure the current object pose of the virtual target object corresponding to the target object 310 to correspond to the data p2 recorded in the data element 311b.

However, since there is no content information corresponding to the recording time interval I02 in the data array 321, the processor 104 may maintain the virtual target object corresponding to the target object 320 (for example, without changing its pose in the played back 3D visual content).

Based on the similar principle, the processor 104 may accordingly configure the current object poses of the virtual target objects respectively corresponding to the target object 330, the target object 340, and the target object 350 in the recording time interval I02, the details of which will not be repeated herein.

In an embodiment, the software may also allow the user to adjust the playback progress of the 3D visual content.

In the first embodiment, since each recording time interval is recorded with corresponding content information, the processor 104 may directly configure at least one of the current input event of the virtual input device object, the current object pose of the virtual target object, and the current 3D object information of the first 3D content object based on the above-described method.

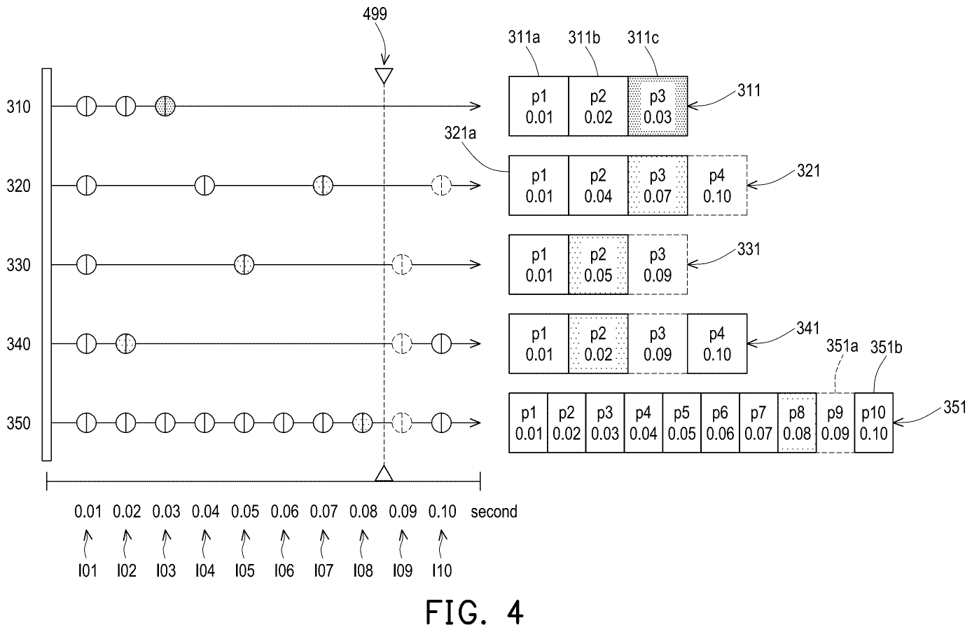

However, in the second embodiment, since not every recording time interval has the corresponding recorded content information, the processor 104 may use the method described in FIG. 4 to obtain content information for configuring at least one of the current input event of the virtual input device object, the current object pose of the virtual target object, and the current 3D object information of the first 3D content object.

Referring to FIG. 4, FIG. 4 is a schematic diagram of playing back 3D visual content according to a specified time point according to the embodiment of FIG. 3.

In the embodiment, in response to determining that the playback progress is configured to correspond to the specified time point, the processor 104 may determine whether the data array includes a specific data element corresponding to the specified time point.

In an embodiment, in response to determining that the data array includes the specific data element corresponding to the specified time point, the processor 104 may start to play back the recorded 3D visual content from the specified time point based on the content information recorded by the specific data element. On the other hand, in response to determining that the data array does not include the specific data element corresponding to the specified time point, the processor 104 may find the reference data element in the data array based on the specified time point, and may start to play back the recorded 3D visual content from the specified time point based on the content information recorded by the reference data element.

In the embodiment of finding the reference data element, in response to determining that there is at least one first data element in the data array that is later than the specified time point, the processor 104 uses the oldest data element in the at least one first data element as the reference data element. On the other hand, in response to determining that there is only at least one second data element in the data array that is earlier than the specified time point, the processor 104 uses the latest data element in the at least one second data element as the reference data element.

In FIG. 4, it is assumed that the playback progress of the 3D visual content is manually adjusted by the user to correspond to a specified time point 499 (approximately 0.085 ms).

Taking the target object 310 as an example, the processor 104 may determine according to the above teachings that the data array 311 does not include a specific data element corresponding to the specified time point 499. In this case, the processor 104 may accordingly find the reference data element corresponding to the target object 310 in the data array 311 based on the specified time point 499.

In the embodiment, since there are only data elements 311a to 311c (which may be understood as the above-mentioned second data elements) that are earlier than the specified time point 499 in the data array 311, the processor 104 may use the latest data element (i.e., the data element 311c) among the data elements 311a to 311c as the reference data element.

Based on this, the processor 104 may configure the current object pose of the virtual target object corresponding to the target object 310 to correspond to the data p3 recorded in the data element 311c, and accordingly, the virtual target object corresponding to the target object 310 is presented in the 3D visual content whose playback progress is configured to the specified time point 499.

Taking the target object 350 as an example again, the processor 104 may determine according to the above teachings that the data array 351 does not include a specific data element corresponding to the specified time point 499. In this case, the processor 104 may accordingly find the reference data element corresponding to the target object 350 in the data array 351 based on the specified time point 499.

In the embodiment, since there are data elements 351a and 351b in the data array 351 that are later than the specified time point 499 (which may be understood as the above-mentioned first data elements), the processor 104 may use the oldest data element among the data elements 351a and 351b (i.e., the data element 351a) as the reference data element.

Based on this, the processor 104 may configure the current object pose of the virtual target object corresponding to the target object 350 to correspond to data p9 recorded in the data element 351a, and accordingly, the virtual target object corresponding to the target object 350 is presented in the 3D visual content whose playback progress is configured to the specified time point 499.

Based on the similar principle, the processor 104 may accordingly configure the current object poses of the virtual target objects respectively corresponding to the target object 320, the target object 330, and the target object 340 in the 3D visual content whose playback progress is configured to the specified time point 499, the details of which will not be repeated here.

In another embodiment, it is assumed that the specified time point of the playback progress is configured to correspond to 0.03 ms. In this case, since the data array 311 includes a specific data element (i.e., the data element 311c) corresponding to the specified time point, the processor 104 may start to play back the recorded 3D visual content from 0.03 ms based on the content information recorded by the specific data element.

For example, the processor 104 may configure the current object pose of the virtual target object corresponding to the target object 310 to correspond to the data p3 recorded in the data element 311c, and accordingly, the virtual target object corresponding to the target object 310 is presented in the 3D visual content whose playback progress is configured as 0.03 ms.

Based on the above principles, the processor 104 may configure the current object poses of the virtual target objects corresponding to the target objects 310, 320, 330, 340, and 350 in the 3D visual content whose playback progress is configured to the specified time point in response to any specified time point set by the user, the details of which will not be repeated here.

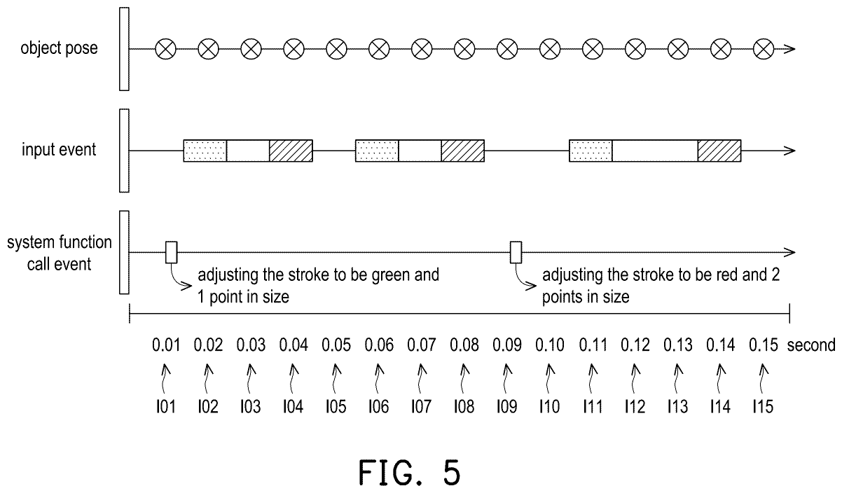

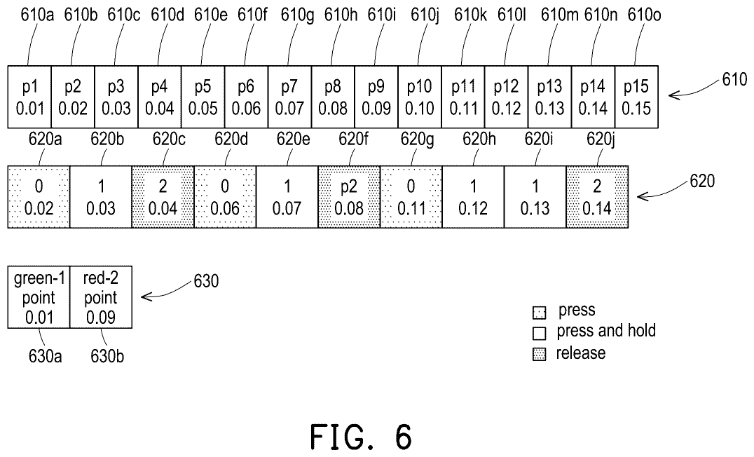

Referring to FIG. 5 and FIG. 6, FIG. 5 is a schematic diagram of recording content information according to an embodiment of the disclosure, and FIG. 6 is a schematic diagram of a data array according to FIG. 5.

In the embodiment, it is assumed that the recording phase under consideration includes a recording time interval I01 to a recording time interval I15 (where the individual lengths of the recording time interval I01 to the recording time interval I15 are, for example, 10 ms).

In the embodiment, the processor 104 may, for example, detect various events associated with the handheld controller and record them as content information accordingly.

As mentioned previously, a handheld controller may be considered both as a target object that may be tracked and as an input device that may be used to generate input events. In this case, the object pose corresponding to the handheld controller in the recording time interval I01 to the recording time interval I15 may be recorded as data elements 610a to 610o in a data array 610 depicted in FIG. 6 respectively (for example, data p1 to data p15).

In the embodiment, assuming that the handheld controller is used as a brush to draw/write in the 3D space, a certain button (hereinafter referred to as A) on the handheld controller, for example, may be used to perform such a behavior. For example, when a button A is pressed and held, the processor 104 may determine that the user (for example, a teacher) wants to draw/write, and the processor 104 may render the corresponding pattern trajectory based on the movement trajectory of the handheld controller. On the other hand, when the button A is released, the processor 104 may determine that the user (for example, a teacher) is no longer drawing/writing, and the processor 104 may stop rendering the corresponding pattern trajectory based on the movement trajectory of the handheld controller, but the disclosure is not limited thereto.

In FIG. 5, assuming that the button A is pressed in the recording time interval I02, the processor 104 may determine that an input event (indicated by a dotted grid) corresponding to the button A being pressed occurs in the recording time interval I02. Next, assuming that the button A is kept pressed in the recording time interval I03, the processor 104 may determine that an input event (indicated by a white grid) corresponding to the button A being kept pressed occurs in the recording time interval I03. Afterwards, assuming that the button A is released in the recording time interval I04, the processor 104 may determine that an input event (indicated by a grid with oblique lines) corresponding to the button A being released occurs in the recording time interval I04.

In the embodiment, input events corresponding to the handheld controller in the recording time interval I02 to the recording time interval I04 may be recorded as data elements 620a to 620c in a data array 620 depicted in FIG. 6 respectively. In FIG. 6, the number “0” in the data element 620a may represent that the button A is pressed; the number “1” in data element 620b may represent that the button A is pressed and held; the number “2” in the data element 620c may represent that the button A is released, but the disclosure is not limited thereto.

In addition, it is assumed that the button A is pressed in the recording time interval I06, kept pressed in the recording time interval I07, and released in the recording time interval I08, then the processor 104 may determine that an input event corresponding to the button A being pressed occurred in the recording time interval I06, an input event corresponding to the button A being kept pressed occurred in the recording time interval I07, and an input event corresponding to the button A being released occurred in the recording time interval I08.

In the embodiment, input events corresponding to the handheld controller in the recording time interval I06 to the recording time interval I08 may, for example, be recorded as data elements 620d to 620f in the data array 620 depicted in FIG. 6 respectively.

Based on the above principles, the input events corresponding to the button A in the recording time interval I11 to the recording time interval I15 should be deduced accordingly, and the relevant input events may, for example, be recorded as data elements 620g to 620j in the data array 620 depicted in FIG. 6 respectively, the details of which will not be repeated here.

In addition, assuming that the stroke of the above-mentioned brush is changed to green in the recording time interval I01 and the size is 1 point, the processor 104 may determine that a system function call event occurs in the recording time interval I01. In the embodiment, the system function call events corresponding to the handheld controller in the recording time interval I01 may, for example, be recorded as data elements 630a in a data array 630 depicted in FIG. 6 respectively.

In FIG. 5, assuming that the stroke of the above-mentioned brush is changed to red in the recording time interval I09 and the size is 2 points, the processor 104 may determine that a system function call event occurs in the recording time interval I09. In the embodiment, the system function call events corresponding to the handheld controller in the recording time interval I09 may be recorded, for example, as data elements 630b in the data array 630 depicted in FIG. 6 respectively.

In embodiments of the disclosure, the system function call event may include a pause event.

For example, in some teaching scenarios, the teacher may use an input device and/or a target object to demonstrate certain specific actions (such as operating a virtual object). At this time, the processor 104 may create a corresponding pause event after the teacher completes the demonstration.

Later, during the playback of the 3D visual content, after the learner has finished watching the above demonstration, the processor 104 may pause the playback of the 3D visual content in response to the above pause event, and wait for the learner to perform the same specific action using the input device and/or the target object. If the learner successfully performs the same specific action as demonstrated by the teacher, the processor 104 may continue the playback of the 3D visual content. On the contrary, if the learner fails to successfully perform the same specific action as demonstrated by the teacher, the processor 104 may maintain pausing the playback of the 3D visual content.

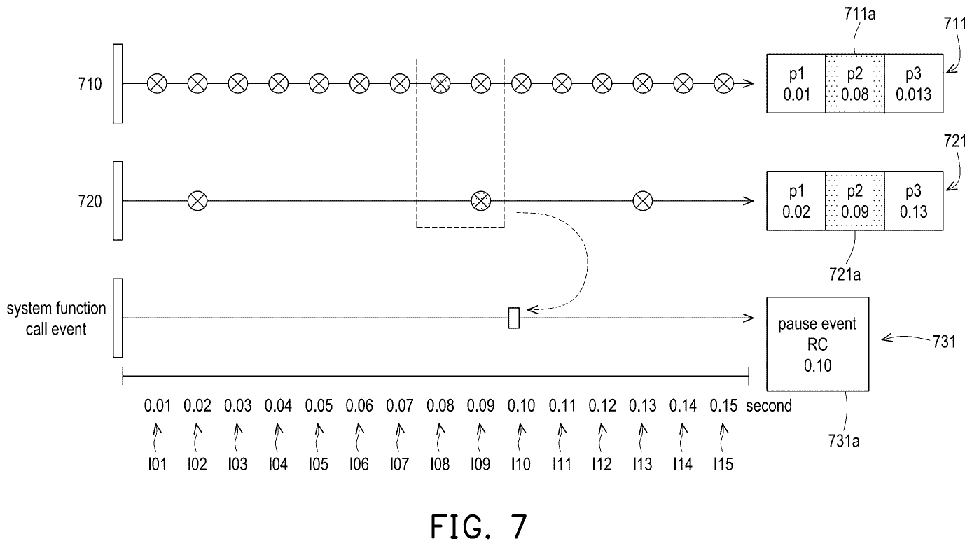

In order to make the above concepts easier to understand, FIG. 7 is provided below for further explanation.

Referring to FIG. 7, FIG. 7 is a schematic diagram of a pause event according to an embodiment of the disclosure.

In FIG. 7, it is assumed that the recording phase under consideration includes the recording time interval I01 to the recording time interval I15, and the object poses of target objects 710 and 720 are respectively recorded in the corresponding data arrays 711 and 721.

In the embodiment, it is assumed that the teacher uses the target object 710 to perform an action (hereinafter referred to as M1) in the recording time interval I08 and maintains it, and uses the target object 720 to perform an action (hereinafter referred to as M2) in the recording time interval I09 and maintains it, then the related object poses of the target object 710 and the target object 720 may be recorded as data p2 in a data element 711a and data p2 in a data element 721a respectively.

In some embodiments, not only the target object 710 and the target object 720 can be used to perform the actions M1 and M2, other input devices and/or 3D content object can also be used to implement the actions M1 and M2, but the disclosure is not limited thereto.

Thereafter, it is assumed that a pause event is set in the recording time interval I10, and the pause event may record a relative pose RC between the data p2 in the data element 711a and the data p2 in the data element 721a. In this case, a data array 731 corresponding to the system function call event may record a corresponding data element 731a.

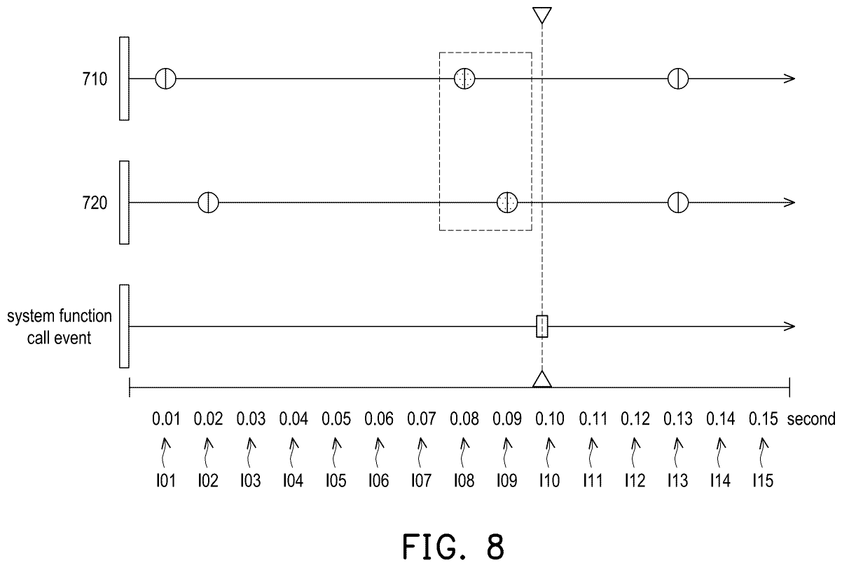

Referring to FIG. 8, FIG. 8 is a playback schematic diagram according to FIG. 7.

In FIG. 8, the processor 104 may play back the recorded 3D visual content based on previous teachings. In this case, the processor 104 may, for example, determine that the teacher performs the action M1 with the target object 710 and maintains it when the playback progress corresponds to the recording time interval I08, and determine that the teacher performs the action M2 with the target object 720 and maintains it when the playback progress corresponds to the recording time interval I09.

Afterwards, when the playback progress changes to correspond to the recording time interval I10, the processor 104 may determine that the current playback time point corresponds to the pause event depicted in FIG. 7 based on the data element 731a depicted in FIG. 7. Based on this, the processor 104 may pause the playback of the recorded 3D visual content and determine whether a system function call event corresponding to the pause event is detected.

In FIG. 8, the processor 104 may detect the current relative pose between the target object 710 and the target object 720 and determine whether the current relative pose is the same as the relative pose RC recorded in the data element 731a.

If the current relative pose is the same as the relative pose RC recorded in the data element 731a, this means that the learner has correctly imitated the action M1 and the action M2 performed by the teacher during the recording phase. In this case, the processor 104 may determine that the system function call event corresponding to the above-mentioned pause event has been detected, and may continue the playback of the 3D visual content.

On the other hand, if the current relative pose is different from the relative pose RC recorded in the data element 731a, this means that the learner did not correctly imitate the action M1 and the action M2 performed by the teacher during the recording phase. In this case, the processor 104 may determine that the system function call event corresponding to the above-mentioned pause event is not detected, and may maintain pausing the playback of the 3D visual content.

In an embodiment, the concepts in FIG. 7 and FIG. 8 may be broadly understood as content information associated with the 3D visual content that may include a pause event corresponding to the i-th recording time interval.

Afterwards, in response to determining that the current playback time point corresponds to the pause event, the processor 104 may pause the playback of the recorded 3D visual content and determine whether a first system function call event corresponding to the pause event is detected (for example, the current relative pose between the target object 710 and the target object 720 is the same as the relative pose RC recorded in the data element 731a).

In response to determining that the first system function call event corresponding to the pause event is detected, the processor 104 may continue the playback of the recorded 3D visual content. On the other hand, in response to determining that the first system function call event corresponding to the pause event is not detected, playback of the recorded 3D visual content is remained paused.

In one embodiment, if the implementation of the actions M1 and M2 in the recording phase involves other input device and/or 3D content object, the actions performed by the learner during the playback phase also needs to involve the associated input device and/or 3D content object, but the disclosure is not limited thereto.

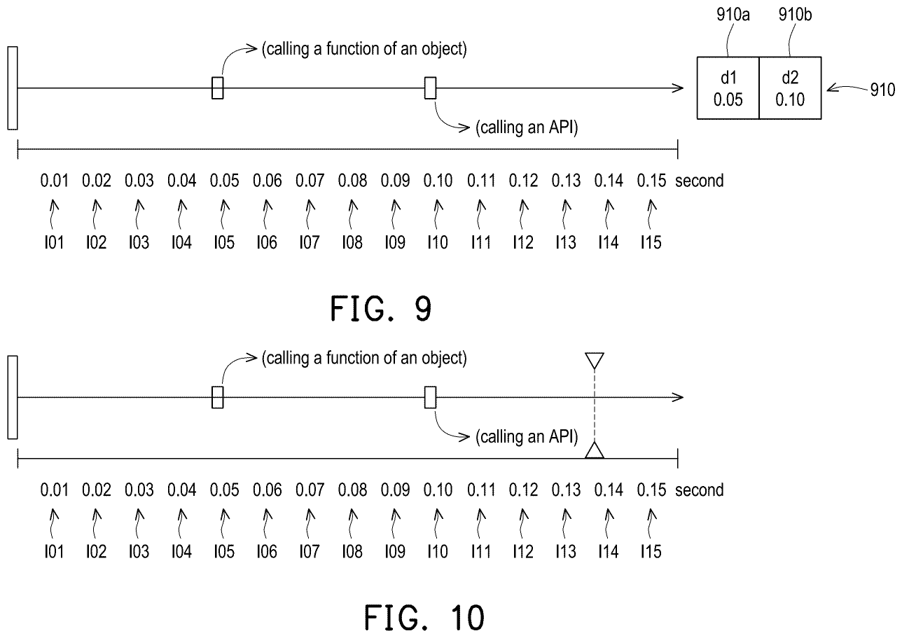

Referring to FIG. 9, FIG. 9 is a schematic diagram of a recording phase according to an embodiment of the disclosure.

In FIG. 9, it is assumed that the function of calling an object appears in the recording time interval I05 of the recording phase (such as adjusting the switch, color temperature and/or brightness of the virtual object, adjusting strokes, etc.), then the processor 104 may determine that a system function call event occurs, and accordingly add a new data element 910a into a data array 910 corresponding to the system function call event. Data d1, for example, records the above-mentioned calling a function of an object, but the disclosure is not limited thereto.

In addition, assuming that an event of calling an API occurs in the recording time interval I10 of the recording phase, the processor 104 may determine that a system function call event occurs, and accordingly add a new data element 910b to the data array 910 corresponding to the system function call event. Data d2, for example, records the above-mentioned event of calling the API, but the disclosure is not limited thereto.

Referring to FIG. 10, FIG. 10 is a schematic diagram of playing back 3D visual content according to FIG. 9. In FIG. 10, the processor 104 may play back the recorded 3D visual content according to previous teachings. In this case, the processor 104 may, for example, perform the function of calling an object based on the data d1 in the data element 910a when the playback progress corresponds to the recording time interval I05. Furthermore, the processor 104 may call the above-mentioned API based on the data d2 in the data element 910b when the playback progress corresponds to the recording time interval I10, but the disclosure is not limited thereto.

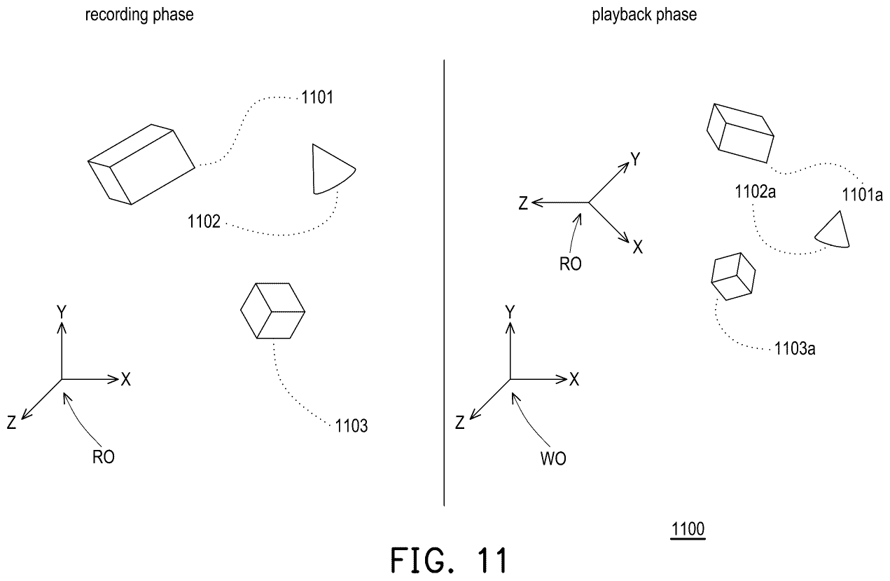

Referring to FIG. 11, FIG. 11 is a schematic diagram of recording coordinate origins according to an embodiment of the disclosure.

In an embodiment, the 3D object information of the 3D content object includes a content object pose of the 3D content object, and the content object pose is used to represent the relative pose between the 3D content object and a first recording coordinate origin RO during the recording phase. The first recording coordinate origin RO is different from a world coordinate origin WO.

In the embodiment of the disclosure, the first recording coordinate origin RO is, for example, the origin of the coordinate system used by the processor 104 to track object poses of various target objects. In this case, the object pose of the target object 110 is, for example, the relative pose between the target object 110 and the first recording coordinate origin RO, but the disclosure is not limited thereto.

Taking FIG. 11 as an example, for 3D content objects 1101, 1102, and 1103, the processor 104 may record the individual content object poses of the 3D content objects 1101, 1102, and 1103 during the recording phase (which may be presented in the form of six degrees of freedom).

In the embodiment, the content object pose of the 3D content object 1101 is, for example, the relative pose between the 3D content object 1101 and the first recording coordinate origin RO; the content object pose of the 3D content object 1102 is, for example, the relative pose between the 3D content object 1102 and the first recording coordinate origin RO; and the content object pose of the 3D content object 1103 is, for example, the relative pose between the 3D content object 1103 and the first recording coordinate origin RO.

Since the first recording coordinate origin RO is different from the world coordinate origin WO, the processor 104 may present first 3D content objects 1101a, 1102a, and 1103a corresponding to the 3D content objects 1101, 1102, and 1103 in a more flexible manner during the playback phase.

Specifically, in an embodiment, during the process of configuring the current 3D object information of the first 3D content object based on the specific content information corresponding to the i-th recording time interval, the processor 104 may determine the first recording coordinate origin RO in a 3D space 1100, and render the first 3D content object in the 3D space 1100 based on the first recording coordinate origin RO and the current content object pose of the first 3D content object. The coordinate origin of the 3D space 1100 is the world coordinate origin WO.

Taking FIG. 11 as an example, the processor 104 may determine the first recording coordinate origin RO in the 3D space 1100, and render the first 3D content objects 1101a, 1102a, and 1103a in the 3D space 1100 based on the first recording coordinate origin RO and the current content object pose of the first 3D content objects 1101a, 1102a, and 1103a.

In other words, during the playback phase, the processor 104 may not render the first 3D content objects 1101a, 1102a, and 1103a based on the world coordinate origin WO, but render the first 3D content objects 1101a, 1102a, and 1103a based on the separately determined first recording coordinate origin RO.

In an embodiment, in response to determining that the first recording coordinate origin RO is moved when the 3D visual content is played back, the processor 104 may adjust the first 3D content objects 1101a, 1102a, and 1103a rendered in the 3D space 1100 based on the moved first recording coordinate origin RO and the current content object pose of the first 3D content objects 1101a, 1102a, and 1103a.

In this case, the user may arbitrarily adjust the position/scale/rotation of the first recording coordinate origin RO according to the requirements, and then accordingly change the presentation manner of the first 3D content objects 1101a, 1102a, and 1103a in the played back 3D visual content.

In some embodiments, although the teacher operates the input device, the target object, and interacts with the 3D content objects during the recording phase, the processor 104 may replace the teacher with any virtual object/character/avatar during the playback phase.

For example, it is assumed that during the recording phase, the teacher demonstrates actions and the previously mentioned software records them. During the playback phase, the software may be configured to demonstrate the same action with an animated character or other similar avatar, but the disclosure is not limited thereto.

In summary, the technical solution proposed by the embodiment of the disclosure may record more diversified content information (such as input events on the input device, system function call events, etc.) during the recording phase of the 3D visual content, and such information may be combined into various forms of playback data, which may make the mechanism for recording/playing back 3D visual content richer and more flexible.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. A method for managing visual content, executed by a host, comprising:
during a recording phase for recording 3D visual content, recording content information associated with the 3D visual content, wherein the content information associated with the 3D visual content comprises at least one of an input event occurring on an input device, an object pose of a target object, and 3D object information corresponding to a 3D content object; and
during a playback phase for playing back the recorded 3D visual content, playing back the recorded 3D visual content based on the content information of the recorded 3D visual content.

2. The method according to claim 1, wherein the content information of the 3D visual content further comprises an audio signal received by an audio receiving device during the recording phase.

3. The method according to claim 1, wherein the content information of the 3D visual content further comprises a system function call event associated with the 3D visual content.

4. The method according to claim 1, wherein the recording phase is divided into a plurality of recording time intervals, the plurality of recording time intervals comprise an i-th recording time interval, and the method comprises:
in response to determining that the content information detected in the i-th recording time interval is different from reference content information, recording the content information detected in the i-th recording time interval, and determining the content information detected in the i-th recording time interval as the reference content information, wherein i is an index value; and
in response to determining that the content information detected in the i-th recording time interval is the same as the reference content information, not recording the content information detected in the i-th recording time interval, and maintaining the reference content information.

5. The method according to claim 4, wherein recording the content information detected in the i-th recording time interval comprises:
adding a data element corresponding to the i-th recording time interval into a data array, wherein the data element corresponding to the i-th recording time interval records the content information detected in the i-th recording time interval.

6. The method according to claim 5, wherein playing back the recorded 3D visual content comprises:
in response to determining that a playback progress is configured to correspond to a specified time point, determining whether the data array comprises a specific data element corresponding to the specified time point;
in response to determining that the data array comprises the specific data element corresponding to the specified time point, starting to play back the recorded 3D visual content from the specified time point based on the content information recorded by the specific data element;
in response to determining that the data array does not comprise the specific data element corresponding to the specified time point, finding a reference data element in the data array based on the specified time point, and starting to play back the recorded 3D visual content from the specified time point based on the content information recorded by the reference data element.

7. The method according to claim 6, wherein finding the reference data element in the data array based on the specified time point comprises:
in response to determining that there is at least one first data element in the data array that is later than the specified time point, using an oldest data element in the at least one first data element as the reference data element; and
in response to determining that there is only at least one second data element in the data array that is earlier than the specified time point, using a latest data element in the at least one second data element as the reference data element.

8. The method according to claim 1, wherein the recording phase is divided into a plurality of recording time intervals, the plurality of recording time intervals comprise an i-th recording time interval, the content information associated with the 3D visual content comprises a pause event corresponding to the i-th recording time interval, and playing back the recorded 3D visual content comprises:
in response to determining that a current playback time point corresponds to the pause event, pausing a playback of the recorded 3D visual content, and determining whether a first system function call event corresponding to the pause event is detected;
in response to determining that the first system function call event corresponding to the pause event is detected, continuing the playback of the recorded 3D visual content;
in response to determining that the first system function call event corresponding to the pause event is not detected, maintaining pausing the playback of the recorded 3D visual content.

9. The method according to claim 1, wherein the recording phase is divided into a plurality of recording time intervals, the plurality of recording time intervals comprise an i-th recording time interval, and playing back the recorded 3D visual content comprises:
in response to determining that a current playback time point of the playback phase corresponds to the i-th recording time interval, obtaining specific content information corresponding to the i-th recording time interval from the content information associated with the 3D visual content;
configuring at least one of a current input event of a virtual input device object, a current object pose of a virtual target object, and current 3D object information of a first 3D content object based on the specific content information corresponding to the i-th recording time interval, wherein the virtual input device object, the virtual target object, and the first 3D content object are virtual objects in the played back 3D visual content, and respectively correspond to the input device, the target object, and the 3D content object.

10. The method according to claim 9, wherein the 3D object information of the 3D content object comprises a content object pose of the 3D content object, the content object pose is used to represent a relative pose between the 3D content object and a first recording coordinate origin during the recording phase, and the first recording coordinate origin is different from a world coordinate origin.

11. The method according to claim 10, wherein configuring the current 3D object information of the first 3D content object based on the specific content information corresponding to the i-th recording time interval comprises:
determining the first recording coordinate origin in a 3D space, and rendering the first 3D content object in the 3D space based on the first recording coordinate origin and a current content object pose of the first 3D content object, wherein a coordinate origin of the 3D space is the world coordinate origin.

12. The method according to claim 11, further comprising:
in response to determining that the first recording coordinate origin is moved when the 3D visual content is played back, adjusting the first 3D content object rendered in the 3D space based on the moved first recording coordinate origin and the current content object pose of the first 3D content object.

13. A host, comprising:
a storage circuit, configured to store a program code; and
a processor, coupled to the storage circuit, and configured to access the program code to execute:
during a recording phase for recording 3D visual content, recording content information associated with the 3D visual content, wherein the content information associated with the 3D visual content comprises at least one of an input event occurring on an input device, an object pose of a target object, and 3D object information corresponding to a 3D content object; and
during a playback phase for playing back the recorded 3D visual content, playing back the recorded 3D visual content based on the content information of the recorded 3D visual content.

14. The host according to claim 13, wherein the recording phase is divided into a plurality of recording time intervals, the plurality of recording time intervals comprise an i-th recording time interval, and the processor is configured to execute:
in response to determining that the content information detected in the i-th recording time interval is different from reference content information, recording the content information detected in the i-th recording time interval, and determining the content information detected in the i-th recording time interval as the reference content information, wherein i is an index value; and
in response to determining that the content information detected in the i-th recording time interval is the same as the reference content information, not recording the content information detected in the i-th recording time interval, and maintaining the reference content information;
wherein the processor is configured to execute:
adding a data element corresponding to the i-th recording time interval in a data array, wherein the data element corresponding to the i-th recording time interval records the content information detected in the i-th recording time interval.

15. The host according to claim 14, wherein the processor is configured to execute:
in response to determining that a playback progress is configured to correspond to a specified time point, determining whether the data array comprises a specific data element corresponding to the specified time point;
in response to determining that the data array comprises the specific data element corresponding to the specified time point, starting to play back the recorded 3D visual content from the specified time point based on the content information recorded by the specific data element;
in response to determining that the data array does not comprise the specific data element corresponding to the specified time point, finding a reference data element in the data array based on the specified time point, and starting to play back the recorded 3D visual content from the specified time point based on the content information recorded by the reference data element;
wherein the processor is configured to execute:
in response to determining that there is at least one first data element in the data array that is later than the specified time point, using an oldest data element in the at least one first data element as the reference data element; and
in response to determining that there is only at least one second data element in the data array that is earlier than the specified time point, using a latest data element in the at least one second data element as the reference data element.

16. The host according to claim 13, wherein the recording phase is divided into a plurality of recording time intervals, the plurality of recording time intervals comprise an i-th recording time interval, the content information associated with the 3D visual content comprises a pause event corresponding to the i-th recording time interval, and the processor is configured to execute:
in response to determining that a current playback time point corresponds to the pause event, pausing a playback of the recorded 3D visual content, and determining whether a first system function call event corresponding to the pause event is detected;
in response to determining that the first system function call event corresponding to the pause event is detected, continuing the playback of the recorded 3D visual content;
in response to determining that the first system function call event corresponding to the pause event is not detected, maintaining pausing the playback of the recorded 3D visual content.

17. The host according to claim 13, wherein the recording phase is divided into a plurality of recording time intervals, the plurality of recording time intervals comprise an i-th recording time interval, and playing back the recorded 3D visual content comprises:
in response to determining that a current playback time point of the playback phase corresponds to the i-th recording time interval, obtaining specific content information corresponding to the i-th recording time interval from the content information associated with the 3D visual content;
configuring at least one of a current input event of a virtual input device object, a current object pose of a virtual target object, and current 3D object information of a first 3D content object based on the specific content information corresponding to the i-th recording time interval, wherein the virtual input device object, the virtual target object, and the first 3D content object are virtual objects in the played back 3D visual content, and respectively correspond to the input device, the target object, and the 3D content object.

18. The host according to claim 17, wherein the 3D object information of the 3D content object comprises a content object pose of the 3D content object, the content object pose is used to represent a relative pose between the 3D content object and a first recording coordinate origin during the recording phase, and the first recording coordinate origin is different from a world coordinate origin;
wherein the processor is configured to execute:
determining the first recording coordinate origin in a 3D space, and rendering the first 3D content object in the 3D space based on the first recording coordinate origin and a current content object pose of the first 3D content object, wherein a coordinate origin of the 3D space is the world coordinate origin.

19. The host according to claim 18, wherein the processor is further configured to execute:
in response to determining that the first recording coordinate origin is moved when the 3D visual content is played back, adjusting the first 3D content object rendered in the 3D space based on the moved first recording coordinate origin and the current content object pose of the first 3D content object.

20. A non-transitory computer-readable storage medium, wherein the non-transitory computer-readable storage medium records an executable computer program, and the executable computer program is loaded by a host to perform the following steps:
during a recording phase for recording 3D visual content, recording content information associated with the 3D visual content, wherein the content information associated with the 3D visual content comprises at least one of an input event occurring on an input device, an object pose of a target object, and 3D object information corresponding to a 3D content object; and
during a playback phase for playing back the recorded 3D visual content, playing back the recorded 3D visual content based on the content information of the recorded 3D visual content.
